(19) United States
(12) Patent Application Publication
(10) Pub. No.: US 2026/0165317 A1
(43) Pub. Date: Jun. 18, 2026

(54) ORGANIC SALTS FOR AGROCHEMICAL FORMULATIONS

(71) Applicant: SYNGENTA CROP PROTECTION AG, Basel (CH)

(72) Inventors: Natalia LEBEDEVA, Durham, NC (US); Adriana COADY, Plattsville (CA); Matthew Douglas John BAUMANN, Plattsville (CA); Andrew James COUGHLIN, Greensboro, NC (US); Emily REID, Plattsville (CA); Alexander Mark HEMING, Basel (CH); Darian BLANCHARD, Guelph (CA)

(73) Assignee: SYNGENTA CROP PROTECTION AG, Basel (CH)

(21) Appl. No.: 18/705,715

(22) PCT Filed: Oct. 7, 2022
(86) PCT No.: PCT/EP2022/077899

§ 371 Date: Apr. 29, 2024

Related U.S. Application Data
(60) Provisional application No. 63/273,625, filed on Oct. 29, 2021.

(51) Int. Cl. A01N 25/22; A01N 37/28; A01N 43/36; A01N 43/56; A01N 43/653; A01N 43/86; A01P 3/00; A01P 7/04

(52) U.S. Cl. CPC A01N 25/22; A01N 37/28; A01N 43/36; A01N 43/56; A01N 43/653; A01N 43/86; A01P 3/00; A01P 7/04

(57) ABSTRACT

The disclosure provides compositions that use organic salts as antifreeze agents, and their methods of use. Specifically, the compositions of the disclosure contain an agrochemical active ingredient and an organic salt. The disclosure also provides for methods of coating seed with the compositions as well as methods of cold treating seeds.

### CROSS-REFERENCE TO RELATED APPLICATIONS

This application claims the benefit of U.S. Provisional Patent Application 63/273,625 filed Oct. 29, 2021.

### TECHNICAL FIELD

This disclosure relates to antifreeze components. In particular, to additives that improve the performance of coating seeds during cold treatment. Specifically, this disclosure relates to organic salts in seed slurry applications.

### BACKGROUND

There is generally a limited window when crops must be planted. Failure to plant during the appropriate window can negatively effect crop yields. In addition, prior to planting, seeds are generally treated with agrochemical formulations in order to facilitate the growth and health of the seeds or plant propagation materials. To this end, producers of crops must have treated and ready to plant material prior to the start of the planting window. However, treatment of seeds and plant propagation materials may be limited in colder months/climates due to the freezing of an agrochemical formulation which attenuates or renders ineffective the application of the agrochemical formulation onto the seeds. Failure to properly applying the agrochemical formulation may result in missing the planting window. Low temperature applications generally occur because application may occur outside, and if not outside, it is often times impracticable to heat entire silos of planting material or heating large warehouses or barns.

Accordingly, what is needed is an improved agrochemical formulation that allows for application of the formulation during cold temperatures to allow farmers flexibility for early seed coating application or extended planting seasons.

Moreover, agrochemical formulations are often stored or manufactured in locations with below freezing temperatures. Indeed, it is often beneficial to develop formulations which function across various regions/climates in order to allow transfer of agrochemicals between such regions to alleviate supply chain issues. However, if an agrochemical formulation is susceptible to freezing or is improperly formulated, the agrochemical formulation can fail due to the cold temperatures-making the composition unsuitable for use/sale.

Accordingly, what is needed are agrochemical formulations which can pass cold temperatures.

### SUMMARY

Embodiments include a composition, and more particularly a composition for applying to plant seeds, having an agrochemical active ingredient, about 5-20% (w/w) of at least one organic salt, and water.

Additional Embodiments include a combination package having a first package comprising a aqueous seed treatment formulation, and a second package comprising a solution comprising 25-90% (w/w) at least one organic salt, wherein the second package is about 5 to 100% v/v of the first package.

More embodiments include a method for seed treatment including combining a seed treatment formulation with a solution comprising 15-90% (w/w) at least one organic salt, where the solution is about 5 to 1000% v/v of the seed treatment formulation to form a slurry.

Another embodiment includes a composition, and more particularly a composition for applying to plant seeds, having an agrochemical active ingredient, about 1-7% (w/w) of at least one organic salt, and about 5-20% (w/w) an antifreeze agent which is not the at least one organic salt.

An additional embodiment includes a method of adding an organic salt to a formulation, and more particularly to a seed treatment formulation, until the organic salt is present in the seed treatment formulation at about 5-20% (w/w).

### BRIEF DESCRIPTION OF THE DRAWINGS

FIG. 1 shows the rheology profile of various additives (viscosity vs temperature).

FIG. 2 shows germination data of seeds over time.

FIG. 3 shows germination data of barely and wheat.

FIG. 4 shows germination data of barely and wheat.

FIG. 5 is an image of seeds coated with various seed treatments.

### DETAILED DESCRIPTION

Surprisingly, it has been found that the inclusion of an organic salt as a formulation additive improves the performance of agrochemical formulations for coating seeds during cold treatment without negatively impacting health of the seeds.

Before certain embodiments are described in greater detail, it is to be understood that this disclosure is not limited to certain embodiments described, as such may, of course, vary. It is also to be understood that the terminology used herein is for the purpose of describing certain embodiments only, and is not intended to be limiting, since the scope of the present disclosure will be limited only by the appended claims.

Described herein are several definitions. Such definitions are meant to encompass grammatical equivalents.

Unless otherwise required by context, singular terms as used herein and in the claims shall include pluralities and plural terms shall include the singular.

The use of “or” means “and/or” unless stated otherwise. Furthermore, the use of the terms “comprising,” “having,” “including,” as well as other forms, such as “includes” and “included,” are intended to be inclusive and mean that there may be additional elements other than the listed elements. Also, terms such as “element” or “component” encompass both elements and components comprising one unit and elements and components that comprise more than one subunit unless specifically stated otherwise.

As used herein, the term “about” when referring to a measurable value such as an amount, a temporal duration, and the like, is meant to encompass variations of between, e.g., ±20% and ±0.1%. Such variations, however, are dependent on the specific component referred to and the context as understood by a person of ordinary skill in the art.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, representative illustrative methods, and materials are now described.

It is noted that, as used herein and in the appended claims, the singular forms “a,” “an,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Each of the individual embodiments described and illustrated herein has discrete components and features which may be readily separated from or combined with the features of any of the other several embodiments without departing from the scope or spirit of the present disclosure. Any recited method can be carried out in the order of events recited or in any other order which is logically possible.

### Compositions

Compositions of the disclosure can take any form. Formulation types include a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil miscible flowable (OF), an oil miscible liquid (OL), a soluble concentrate (SL), an ultra-low volume suspension (SU), an ultra-low volume liquid (UL), a dispersible concentrate (DC), or any technically feasible formulation in combination with agriculturally acceptable adjuvants.

Preferred compositions are aqueous solutions, dispersions, suspensions, emulsions, or suspoemulsions.

The average size of the suspended particles is 0.1 to 20, specifically 1.5 to 5 microns when measured with a laser particle analyzer, e.g a CILAS 920 apparatus.

The viscosity of the compositions is 200 to 600, more specifically 300 to 500 cP when measured with a Brookfield viscosity meter at −5° C.

The viscosity of the compositions is 200 to 1100, 300 to 700 cP, or 200 to 600 cP, when measured with a Brookfield viscosity meter at −15° C.

### Compositions for Applying to Seeds

In certain embodiments, the disclosure provides for compositions formulated for application to a plant seed containing an agrochemical active ingredient, an organic salt, and water. The compositions may contain additional ingredients. For example, the composition may also contain a surfactant and a pigment. These compositions may be applied to a plant seed as a slurry.

The compositions of the disclosure may be used during cold treatment of seeds and are uniquely formulated to be fluid at these subfreezing environment (such as e.g. about-17° C. or about −5° C.). In specific embodiments, the temperature of the seed may be as low as about −25° C. In certain embodiments, the compositions are specifically formulated to avoid formation of ice crystals and maintain viscosity.

In specific embodiments, the composition is formulated such that the slurry remains a liquid at least −15° C. In some embodiments, the slurry can be a liquid at least-10° C. or at least −5° C.

### Organic Salt

The compositions of the disclosure contain one or more organic salt. As used herein, an organic salt is a C₁-C₆ carboxylic acid salt. The organic salt may be potassium acetate, potassium formate, or a combination thereof. In one embodiment, the organic salt is potassium acetate. In another embodiment, the organic salt is potassium formate. In yet another embodiment, the organic salt potassium acetate and potassium formate. In certain embodiments, the organic salt has a potassium ion. In other embodiments, the organic salt has a sodium ion, for example, sodium acetate or sodium formate. Other salts include potassium succinate, potassium propionate, valeric acid potassium salt, malonic acid potassium salt, sodium propionate. The compositions of the disclosure include combinations thereof.

The organic salt may be present in an amount of about 1 to about 20% (w/w) of the composition. Accordingly, in embodiments of the disclosure, the composition contains from about 3% (w/w) to about 14% (w/w), alternatively from about 4% (w/w) to about 12% (w/w), alternatively from about 5% (w/w) to about 10% (w/w), alternatively from about 5% (w/w) to about 9% (w/w) of the organic salt, alternatively from about 6% (w/w) to about 9% (w/w), alternatively from about 7% (w/w) to about 8% (w/w) of an organic salt, such as potassium acetate, potassium formate, or a combination thereof. In specific embodiments, the amount organic salt present may be from about 1 to about 7% (w/w) of the composition. Accordingly, in embodiments of the disclosure, the composition contains from about 2 to about 5% (w/w) or about 3 to about 4% (w/w). Accordingly, the salt may be present at about anyone of 1%, 2%, 3%, 4%, 5%, 6%, 7%, 8%, 9%, 10%, 11%, 12%, 13%, 14%, or 15% (w/w).

In general, the organic salt is dissolved within the composition, i.e., not in a solid/crystalline form.

In specific embodiments, the amount of organic salt is excess of at least one agrochemical in the composition on a mole basis by the w/w amounts described above.

In alternative embodiments, the organic salt can be present as an additive formulation component to be added to the compositions for treating seeds. In embodiments where the organic salt is an additive formulation component, the additive formulation component can have about 15-90% (w/w) at least one organic salt. The at least one organic salt may be present in amount from about 25% (w/w) to about 70% (w/w), alternatively about 35% (w/w), about 65% (w/w), about 70% (w/w), alternatively at least 65% (w/w). In some embodiments, remainder of the additive formulation component is water. In other embodiments, the additive formulation component further comprises one or more solvents, surfactants, or antifreeze agents.

In one embodiment, the organic salt is potassium acetate. The potassium acetate may be present in amount from about 60% (w/w) to about 70% (w/w), alternatively about 60% (w/w), about 65% (w/w), about 70% (w/w), alternatively at least 65% (w/w).

In one embodiment, the organic salt is potassium formate. The potassium formate may be present in amount from about 60% (w/w) to about 70% (w/w), alternatively about 60% (w/w), about 65% (w/w), about 70% (w/w), alternatively at least 65% (w/w).

In yet another embodiment, the organic salt is potassium acetate and potassium formate. In certain embodiments, the composition may contain from about 55% (w/w) to about 75% (w/w), alternatively from about 60% (w/w) to about 70% (w/w) of potassium acetate and potassium formate. In certain embodiments, the potassium acetate and potassium formate are present in equal amounts. In other embodiments, the amount of potassium acetate exceeds the amount of potassium formate. In yet another embodiment, the amount of potassium formate exceeds the amount of potassium acetate.

In one embodiment, the composition contains from about 30% (w/w) to about 40 (w/w) of potassium acetate and from about 30% (w/w) to about 40 (w/w) of potassium formate, wherein the combined amount of potassium acetate and potassium formate does not exceed about 75% w/w.

The additive formulation component can be about 5 to 20% (v/v) the composition for treating seeds. In specific embodiments, the additive formulation component is about 5 to 15% (v/v), about 7 to 13% (v/v), or even about 8 to 11% (v/v).

In an alternate embodiments, the organic salt may be used in combination with an alcohol such as ethanol. For such embodiments, the amounts of the organic salt used may be lower. For example, from about 45% (w/w) to about 55% (w/w), alternatively about 50% (w/w) of the organic salt (e.g. potassium acetate or potassium formate) may be used in combination with from about 15% (w/w) to about 25% (w/w), from about 17% (w/w) to about 22% (w/w), alternatively about 20% (w/w) of the alcohol (e.g. ethanol).

### Surfactant

The compositions can contain at least about 2% up to about 15% w/w of a surface-active agent. In one embodiment, the compositions contain from 3% up to about 7% w/w of a surface-active agent.

The surface active agent (a) comprises (a1) at least one anionic surfactant. In general, the anionic surfactant may be any known in the art. Suitable anionic surfactants are in general oligomers and polymers, as well as polycondensates, which contain a sufficient number of anionic groups to ensure their water-solubility. Suitable anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C12-C15 alkanols or polyalkoxylated C12-C15 alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-M-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Specific examples of suitable anionic surfactants include: Geropon T77 (Rhodia) (N-methyl-N-oleoyltaurate Na salt); Soprophor 4D384 (Rhodia) (tristyrylphenol sulphate); Reax 825 (Westvaco) (ethoxylated lignin sulfonate); Stepfac 8171 (Stepan) (ethoxylated nonylphenol phosphate ester); Ninate 401-A (Stepan) (calcium alkylbenzene sulfonate); Emphos CS-131 (Witco) (ethoxylated nonylphenol phosphate ester); and Atphos 3226 (Uniqema) (ethoxylated tridecylalcohol phosphate ester). Suitable anionic surfactants can be prepared by methods known per se and also are commercially available.

The surface-active agent comprising a1) at least one anionic surfactant may optionally further comprise a2) one or more nonionic surfactants. As used herein, “nonionic surfactants” are different compounds from the water-dispersible and water-soluble polymers b) described herein.

Exemplary nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C8-C22 alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, and mono- and diesters of ethylene glycol and mixtures thereof.

Specific examples of suitable nonionic surfactants include: Genapol X-060 (Clariant) (ethoxylated fatty alcohol); Sorpohor BSU (Rhodia) ethoxylated tristyrylphenol; Makon TD-6 (Stepan) (ethoxylated fatty alcohol); BRIJ 30 (Uniqema) (ethoxylated lauryl alcohol); Witconol CO-360 (Witco) (ethoxylated castor oil); and Witconol NP-60 (Witco) (ethoxylated nonylphenol). Suitable nonionic surfactants can be prepared by methods known per se and also are commercially available.

In addition to anionic and nonionic surfactants, certain cationic or zwitterionic surfactants a3) also are suitable for use in the present invention such as alkanol amides of C8-C18 fatty acids and C8-C18 fatty amine polyalkoxylates, C10-C18 alkyldimethylbenzylammonium chlorides, coconut alkyldimethylaminoacetic acids, and phosphate esters of C8-C18 fatty amine polyalkoxylates.

In one embodiment, a mixture of surfactants (a1), (a2) and optionally (a3) is employed as follows:
(1) 0.5-4% w/w of a wetting agent selected from (a1) at least one anionic surfactant. Suitable anionic surfactant wetting agents include sulfoalkylamides and salts thereof such as N-methyl-N-oleoyltaurate Na salt, alkylaryl sulfonates such as alkylbenzene sulfonates and alkylnaphthalene sulfonates and salts thereof and salts of ligninsulfonic acid;
(2) 1-4% w/w of a dispersing agent selected from (a1) at least one anionic surfactant. Suitable anionic surfactant dispersing agents include sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts;
(3) 1 to 5% w/w of an emulsifying agent selected from (a1) at least one anionic surfactant, (a2) at least one nonionic surfactant and a mixture thereof. Suitable anionic/nonionic surfactant emulsifiers include salts of ethoxylated alkylphenols, polyoxyethylene-polyoxypropylene alkylphenols, (fatty) alcohol ethoxylates and ethoxylated tristyrylphenols.

### Dispersible Polymers

The composition can also include at least one polymer selected from water-soluble and water-dispersible polymers. Suitable dispersible polymers have an average molecular weight of at least about 1,000 up to about 100,000; more specifically at least about 5,000, up to about 100,000. The aqueous compositions generally contain from about 0.5% to about 10% w/w of the composition of dispersible polymer (b). In a specific embodiment, the compositions contain from about 1.0% up to about 5% w/w of a polymer.

Suitable polymers are selected from:
b1)alkyleneoxide random and block copolymers such as ethylene oxide-propylene oxide block copolymers (EO/PO block copolymers) including both EO-PO-EO and PO-EO-PO block copolymers;
ethylene oxide-butylene oxide random and block copolymers,
C2-6 alkyl adducts of ethylene oxide-propylene oxide random and block copolymers,
C2-6 alkyl adducts of ethylene oxide-butylene oxide random and block copolymers,
b2) polyoxyethylene-polyoxypropylene monoalkylethers such as methyl ether, ethyl ether, propyl ether, butyl ether or mixtures thereof.
b3) vinylacetate/vinylpyrrolidone copolymers,
b4)alkylated vinylpyrrolidone copolymers,
b5) polyvinylpyrrolidone, and
b6) polyalkyleneglycol including the polypropylene glycols and polyethylene glycols.

Specific examples of suitable polymers include Pluronic P103 (BASF) (EO-PO-EO block copolymer), Pluronic P65 (BASF) (EO-PO-EO block copolymer), Pluronic P108 (BASF) (EO-PO-EO block copolymer), Vinamul 18160 (National Starch) (polyvinylacetate), Agrimer 30 (ISP) (polyvinylpyrrolidone), Agrimer VA7w (ISP) (vinyl acetate/vinylpyrrolidone copolymer), Agrimer AL 10 (ISP) (alkylated vinylpyrrolidone copolymer), PEG 400 (Uniqema) (polyethylene glycol), Pluronic R 25R2 (BASF) (PO-EO-PO block copolymer), Pluronic R 31R1 (BASF) (PO-EO-PO block copolymer) and Witconol NS 500LQ (Witco) (butanol PO-EO copolymer).

### Rheological Modifiers/Carriers

The composition can also comprise, at least about 0.1 and up to about 20% w/w, more specifically from 5 to about 15% w/w of at least one solid carrier.

The solid carrier is a natural or synthetic solid material that is insoluble in water. This carrier is generally inert and acceptable in agriculture, especially on the treated seed or other propagation material. It can be chosen, for example, from clay, diatomaceous earth, natural or synthetic silicates, titanium dioxide, magnesium silicate, aluminum silicate, talc, pyrophyllite clay, silica, attapulgite clay, dieselguhr, chalk, lime, calcium carbonate, bentonite clay, Fuller's earth, and the like.

### Additional Components

The composition optionally contains at least one thickener.

In one embodiment, the thickener is present in the aqueous composition in an amount from about 0.01% to about 25% w/w, more specifically from 0.02 to 10% w/w.

Illustrative of thickeners (water-soluble polymers which exhibit pseudoplastic properties in an aqueous medium) are gum arabic, gum karaya, gum tragacanth, guar gum, locust bean gum, xanthan gum, carrageenan, alginate salt, casein, dextran, pectin, agar, 2-hydroxyethyl, starch, 2-aminoethyl starch, 2-hydroxyethyl cellulose, methyl cellulose, carboxymethyl cellulose salt, cellulose sulfate salt, polyacrylamide, alkali metal salts of the maleic anhydride copolymers, alkali metal salts of poly(meth)acrylate, and the like.

As suitable thickeners there may also be mentioned attapulgite-type clay, carrageenan, croscarmellose sodium, furcelleran, glycerol, hydroxypropyl methylcellulose, polystyrene, vinylpyrrolidone/styrene block copolymer, hydroxypropyl cellulose, hydroxypropyl guar gum, and sodium carboxymethylcellulose. Xanthan gum is preferred.

The aqueous composition according to the invention can be employed together with the adjuvants customary in formulation technology, biocides, biostats, emulsifiers (lethicin, sorbitan, and the like), antifoam agents or application-promoting adjuvants customarily employed in the art of formulation. In addition, there may be mentioned inoculants and brighteners.

Additionally, a coloring agent, such as a dye or pigment is included in the seed coating so that an observer can immediately determine that the seeds are treated. The dye is also useful to indicate to the user the degree of uniformity of the coating applied. In one embodiment, the composition contains a red pigment. For example, the composition may contain Sunsperse Red.

The pigment may be present in an amount up to 2.5 to 30% w/w, or for example 5 to 20% w/w, or for example, about 15% w/w.

In certain embodiments, the type of pigment used may vary depending on the agricultural active ingredient.

The compositions of the disclosure contain and/or may be applied together or sequentially with further active compounds. These further compounds can be fertilizers or micronutrient donors or other preparations that influence plant growth. They can also be selective herbicides, insecticides, fungicides, bactericides, insect growth regulators, plant growth regulators, nematicides, molluscicides or mixtures of several of these preparations.

### Agrochemical Active Ingredient

Various agrochemical active ingredients may be used in embodiments of the disclosure. Agrochemical active ingredients are generally compounds which are recognized in the art for controlling a pest. Examples of agrochemicals include: herbicides, insecticides, fungicides, bactericides, insect growth regulators, plant growth regulators, nematicides, molluscicides etc. Preferred agrochemicals are fungicides and/or an insecticides. The agrochemical active ingredient may be provided as a wettable powder.

The term “fungicide” as utilized herein is intended to cover compounds active against phytopathogenic fungi that may belong to a very wide range of compound classes. Examples of compound classes to which the suitable fungicidally active compound may belong include both room temperature (25° C.) solid and room temperature liquid fungicides such as: triazole derivatives, strobilurins, carbamates (including thio- and dithiocarbamates), benzimidazoles (thiabendazole), N-trihalomethylthio compounds (captan), substituted benzenes, carboxamides, phenylamides and phenylpyrroles, and mixtures thereof.

The fungicidally active compounds and/or the insecticidal active compounds are employed in a fungicidally and/or insecticidally effective amount in the composition. Mixtures of one or more of the following active compounds are usable as an active component treatment of the seed of the present disclosure. Examples of suitable individual compounds for use in seed treatments are listed below. Where known, the common name is used to designate the individual compounds (q.v, the Pesticide Manual, 12th edition, 2001, British Crop Protection Council).

Suitable triazole derivatives include propiconazole, difenconazole, tebuconazole, tetraconazole and triticonazole. Suitable strobilurins include trifloxystrobin, azoxystrobin, kresoxim-methyl and picoxystrobin. Suitable carbamates include thiram. Suitable substituted benzenes include PCNB and chlorothalonil. Suitable carboxamides include carboxin. Specific phenylamides usable in the compositions and methods include metalaxyl. A specific phenylpyrrole usable in the composition is fludioxonil.

Other suitable fungicidal compounds that may be mentioned are Benomyl (also known as Benlate), Bitertanol, Carbendazim, Capropamid, Cymoxanil, Cyprodinil, Ethirimol, Fenpiclonil, Fenpropimorph, Fluquinconazole, Flutolanil, Flutriafol, Fosetyl-aluminum, Fuberidazole, Guazatine, Hymexanol, Kasugamycin, Imazalil, Imibenconazole, Iminoctadine-triacetate, Ipconazole, Iprodione, Mancozeb, Maneb, Mepronil, Metalaxyl, Metalaxyl-M (Mefenoxam), Metconazole, Metiram, MON 65500 (Silthiopham-ISO proposed), Myclobutanil, Nuarimol, Oxadixyl, Oxine-copper, Oxolinic acid, Pefurazoate, Pencycuron, Prochloraz, Propamocarb hydrochloride, Pyroquilon, Silthiopham—see MON 65500, Tecnazene, Thifluzamide, Thiophenate-methyl, Tolclofos-methyl, Triadimenol, Triazoxide and Triflumizole.

The fungicidally active compounds and/or the insecticidal active compounds are employed in a fungicidally and/or insecticidally effective amount in the composition. Mixtures of one or more of the following active compounds also are usable as an active component treatment of the seed of the present disclosure.

In one embodiment, the agrochemical active ingredient may be one or more of: difenoconazole, sedaxane, mefenoxam, fludioxonil, thiamethoxam, and/or isocycloseram. In one embodiment, the agrochemical active ingredient is a combination of difenoconazole, sedaxane, mefenoxam, and fludioxonil. In another embodiment, the agrochemical active ingredient is a combination of thiamethoxam, difenoconazole, mefenoxam, fludioxonil, and sedaxane. In yet another embodiment, the agrochemical active ingredient is a combination of difenoconazole, sedaxane, mefenoxam, fludioxonil, and isocycloseram. The total amount of active ingredients is generally in the range of from about 0.5% to about 50% (w/w), about 1 to about 40% (w/w), or more specifically, from about 2 to about 20% (w/w) of the entire composition. In specific embodiments, the active ingredients are from about 3 to about 10% w/w of the entire composition. In a specific embodiment, the active ingredients are present at about 8.5% w/w. In some embodiments, each agrochemical active ingredient present in the composition is less than about 40% (w/w), less than about 20% (w/w), or even less than about 10% (w/w).

In one embodiment, the agrochemical active ingredient is a combination of difenoconazole, sedaxane, mefenoxam, and fludioxonil commercially available as Vibrance® Quattro. In another embodiment, the agrochemical active ingredient is a combination of thiamethoxam, difenoconazole, mefenoxam, fludioxonil, and sedaxane commercially available as Cruiser® Vibrance® Quattro.

The total amount of active ingredients is generally in the range of from about 0.5% to about 50% (w/w), more specifically, from 2 to about 20% (w/w). In specific embodiments, the active ingredients are from about 3 to about 10% by weight of the entire composition. In specific embodiments, the composition contains at least two agrochemical active ingredient, at least three agrochemical active ingredients, at least four agrochemical active ingredients, or even at least five agrochemical active ingredients.

In one embodiment, the composition includes about 0.75% (w/w) fludioxonil, about 0.75% (w/w) picarbutrazox, about 1% (w/w) mefenoxam, about 1.5% (w/w) sedaxane, and about 4.25% (w/w) thiabendazole. In a more specific embodiment, the composition includes 0.72% (w/w) fludioxonil, 0.72% (w/w) picarbutrazox, 1.07% (w/w) mefenoxam, 1.43% (w/w) sedaxane, and 4.3% (w/w) thiabendazole.

In one embodiment, the composition includes pydiflumetofen.

In one embodiment, the composition includes about 1% (w/w) fludioxonil, about 17% (w/w) thiamethoxam, about 2.5% (w/w) mefenoxam, about 1% (w/w) sedaxane, about 2% (w/w) thiabendazole, and about 0.5% (w/w) picarbutrazox. In a more specific embodiment, the composition includes 0.85% (w/w) fludioxonil, 17% (w/w) thiamethoxam, 2.56% (w/w) mefenoxam, 0.85% (w/w) sedaxane, 1.7% (w/w) thiabendazole, and 0.34% (w/w) picarbutrazox

In one embodiment, the composition includes about 10% (w/w) tymirium, about 4% (w/w) fludioxonil, about 5% (w/w) difenoconazole, and about 4% (w/w) metalaxyl-M. In a more specific embodiment, the composition includes 10.43% (w/w) tymirium, 4.35% (w/w) fludioxonil, 5.35% (w/w) difenoconazole, and 4.35% (w/w) metalaxyl-M.

In one embodiment, the composition includes about 3.5% (w/w) difenoconazole, about 1% (w/w) mefenoxam, about 1% fludioxonil, about 1.5% (w/w) sedaxane, and about 6% (w/w) thiamethoxam. In a more specific embodiment, the composition includes 3.45% (w/w) difenoconazole, about 0.86% (w/w) mefenoxam, about 0.72% fludioxonil, about 1.44% (w/w) sedaxane, and about 5.75% (w/w) thiamethoxam. In specific embodiments, the composition further includes isocycloseram.

### Antifreeze

The composition can comprise, at least about 3 and up to about 25% w/w of at least one antifreeze agent, more specifically from 5 to about 20% w/w.

Specific examples of suitable antifreezes include ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol and the like.

As a particular subset of suitable antifreeze materials there can be mentioned ethylene glycol, propylene glycol and glycerin.

### Water

The compositions of the disclosure can contain water or can be diluted with water prior to application. The water may present in an amount up to about 70% w/w, in preferred embodiments about 10-60% w/w, or in other embodiments, about 20-55% w/w, and in certain embodiments about 40-45% w/w. The amounts can be much higher for dilution for application, e.g. on the order of 100 times.

In certain embodiments of the disclosure, the compositions may contain any one of the choices of organic salts combined with any one of the choices of surfactants, agrochemical active ingredients, optional pigments, and water shown in Table 1 below.

TABLE 1
Examples of Suitable Compositions of the Disclosure

| | | | Other components |
|---|---|---|---|
| | | | (surfactants, dispersible |
| | | | polymers, rheological |
| | | | modifiers/carriers |
| | | Agrochemical Active | additional components, |
| Organic Salt | Water | Ingredient | etc) |
| about 1 to about 20%; | Up to about 70%; | about 0.5 to about 50%; | about 25 to about 80%; |
| about 3 to about 14%; | about 10-60%; | about 2 to about 20%; | about 30 to about 75%; |
| about 4 to about 12%; | about 20-55%; | about 3 to about 10%; | about 35 to about 70%; |
| about 5 to about 10%; | about 40-45% | about 1 to about 15%; | about 40 to about 65%; |
| about 5 to about 9%; | | about 2 to about 10% | about 45 to about 60%; |
| about 1 to about 7%; | | at least one | about 50% other |
| about 2 to about 5%; | | agrochemical active | components |
| about 3 to about 4% | | ingredient | |
| of an organic salt | | | |
| about 1 to about 15%; | Up to about 70%; | about 0.5 to about 50%; | about 25 to about 80%; |
| about 3 to about 14%; | about 10-60%; | about 2 to about 20%; | about 30 to about 75%; |
| about 4 to about 12%; | about 20-55%; | about 3 to about 10%; | about 35 to about 70%; |
| about 5 to about 10%; | about 40-45% | about 1 to about 15%; | about 40 to about 65%; |
| about 5 to about 9%; | | about 2 to about 10% | about 45 to about 60%; |
| about 1 to about 7%; | | at least one | about 50% other |
| about 2 to about 5%; | | agrochemical active | components |
| about 3 to about 4% | | ingredient | |
| of potassium acetate | | | |
| about 1 to about 15%; | Up to about 70%; | about 0.5 to about 50%; | about 25 to about 80%; |
| about 3 to about 14%; | about 10-60%; | about 2 to about 20%; | about 30 to about 75%; |
| about 4 to about 12%; | about 20-55%; | about 3 to about 10%; | about 35 to about 70%; |
| about 5 to about 10%; | about 40-45% | about 1 to about 15%; | about 40 to about 65%; |
| about 5 to about 9%; | | about 2 to about 10% | about 45 to about 60%; |
| about 1 to about 7%; | | at least one | about 50% other |
| about 2 to about 5%; | | agrochemical active | components |
| about 3 to about 4% | | ingredient | |
| of potassium formate | | | |
| about 1 to about 15%; | Up to about 70%; | about 0.5 to about 50%; | about 25 to about 80%; |
| about 3 to about 14%; | about 10-60%; | about 2 to about 20%; | about 30 to about 75%; |
| about 4 to about 12%; | about 20-55%; | about 3 to about 10%; | about 35 to about 70%; |
| about 5 to about 10%; | about 40-45% | about 1 to about 15%; | about 40 to about 65%; |
| about 5 to about 9%; | | about 2 to about 10% | about 45 to about 60%; |
| about 1 to about 7%; | | at least one | about 50% other |
| about 2 to about 5%; | | agrochemical active | components |
| about 3 to about 4% | | ingredient | |
| of potassium formate | | | |
| and potassium acetate | | | |
| in a ratio of about 0.75 | | | |
| to 1.3:0.75 to 1.3; | | | |
| about 1:1 | | | |

The compositions of the disclosure may also contain inert additives. Such additives include flow enhancers, dispersants, emulsifiers, wetting agents, antifoaming agents, biocides, lubricants, fillers, drift control agents, deposition enhancers, adjuvants, evaporation retardants, freeze protecting agents, insect attracting odor agents, UV protecting agents, fragrances, and the like. Representative anti-foam agents are silicone oils, polydialkylsiloxanes, in particular polydimethylsiloxanes, fluoroaliphatic esters or perfluoroalkylphosphonic/perfluoroalkylphosphonic acids or the salts thereof and mixtures thereof. Suitable antifoams are polydimethylsiloxanes, such as Dow Corning® Antifoam A, Antifoam B or Antifoam MSA. Representative biocides include 1,2-benzisothiazolin-3-one, available as PROXEL® GXL (Arch Chemicals).

### Kits for Slurry Treatment of Seeds

Another aspect of the disclosure is directed to kits for slurry treatment of seeds. In these kits, any of the components of the composition described above may be provided separately. The kits may also include instructions for use.

In one embodiment, the kit comprises an agrochemical active ingredient and a separate composition comprising organic salt. The organic salt may be potassium acetate, potassium formate, or a combination thereof.

The agrochemical active ingredient may be provided as a ready-to-apply or ready to use premix. In other embodiments, the kit comprises a concentrate of the agrochemical active ingredient that is diluted prior to use.

### Examples of Suitable Seeds

The compositions and kits of the present disclosure may be applied to cereal seeds, such as maize, barley, oats, rye, and wheat. In particular, the compositions and kits of the disclosure may be applied to North America cereals, including wheat and barley.

The compositions and kits of the present disclosure may be applied to seeds of dicotyledonous or monocotyledonous crops. Crops of useful plants in which the composition according to the disclosure can be used include perennial and annual crops, such as berry plants for example blackberries, blueberries, cranberries, raspberries and strawberries; cereals for example barley, maize (corn), millet, oats, rice, rye, sorghum triticale and wheat; fiber plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bent grass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, okra, onion, pepper, potato, pumpkin, rhubarb, spinach and tomato; and vines for example grapes.

Crops are to be understood as being those which are naturally occurring, obtained by conventional methods of breeding, or obtained by genetic engineering. They include crops which contain so-called output traits (e.g. improved storage stability, higher nutritional value, and improved flavor).

Crops are to be understood as also including those crops which have been rendered tolerant to herbicides like bromoxynil or classes of herbicides such as ALS-, EPSPS-, GS-, HPPD- and PPO-inhibitors. An example of a crop that has been rendered tolerant to imidazolinones, e.g. imazamox, by conventional methods of breeding is Clearfield® summer canola. Examples of crops that have been rendered tolerant to herbicides by genetic engineering methods include e.g. glyphosate- and glufosinate-resistant maize varieties commercially available under the trade names RoundupReady®, Herculex I®, and LibertyLink®.

Crops are also to be understood as being those which naturally are or have been rendered resistant to harmful insects. This includes plants transformed by the use of recombinant DNA techniques, for example, to be capable of synthesizing one or more selectively acting toxins, such as are known, for example, from toxin-producing bacteria. Examples of toxins which can be expressed include 8-endotoxins, vegetative insecticidal proteins (Vip), insecticidal proteins of bacteria colonizing nematodes, and toxins produced by scorpions, arachnids, wasps, and fungi.

An example of a crop that has been modified to express the Bacillus thuringiensis toxin is the Bt maize KnockOut® (Syngenta Seeds). An example of a crop comprising more than one gene that codes for insecticidal resistance and thus expresses more than one toxin is VipCot® (Syngenta Seeds). Crops or seed material thereof can also be resistant to multiple types of pests (so-called stacked transgenic events when created by genetic modification). For example, a plant can have the ability to express an insecticidal protein while at the same time being herbicide tolerant, for example Herculex IO (Dow AgroSciences, Pioneer Hi-Bred International).

In one embodiment, the compositions of the disclosure may be applied to wheat seeds. In another embodiment, the compositions may be applied to barley seeds.

### Methods of the Disclosure

Another aspect of the disclosure is directed to methods of coating a seed using the compositions or kits of the instant disclosure. The coating can be applied to a seed at any time between harvest of the seed and sowing of the seed. It is preferred that the seed be in a sufficiently durable state that it incurs no or minimal damage, including physical damage or biological damage, during the treatment process.

The seeds may be pre-sized before coating. After coating, the seeds or plant propagules are typically dried and then transferred to a sizing machine for sizing. Such procedures are known in the art. In some embodiments, a composition of the present disclosure is applied as one ingredient of a seed coating. The treated seeds may also be enveloped with a film over-coating to protect the coating. Such over-coatings are known in the art and may be applied using conventional fluidized bed and drum film coating techniques, for example.

The methods generally involve contacting a plant seed with the composition (e.g. slurry). In embodiments where kits are used, the methods also include combining the components of the kit to form the composition prior to contacting the plant seeds with the composition (e.g. slurry). The seed may be contacted by spraying the seed.

The slurry volume used may be adjusted depending on the type of seed treated. In certain embodiments, the slurry volume may range from about 250 ml/100 kg of seed to about 3000 ml/100 kg of seed. In one embodiment, the seed treated is wheat and the slurry volume may range from about 250 ml/100 kg of seed to about 2500 ml/100 kg of seed.

The methods of the disclosure may be combined with treating in cold temperatures.

In one embodiment, the methods of the disclosure are used to treat seeds when they are at a temperature ranging from about −25° C. to about 0° C., from about −25° C. to about-5° C., from about −20° C. to about −5° C., alternatively from about-15° C. to about 0° C., alternatively about −5° C., alternatively about −10° C., alternatively about −15° C., alternatively about −20° C., or alternatively about −25° C.

In certain embodiments of the disclosure, the methods include applying the composition in pulses.

The methods of the disclosure may be applied to any of the examples of seeds mentioned above. In one embodiment, the methods of the disclosure are used to coat North American cereal seeds. In another embodiment, the methods of the disclosure are used to coat barley seeds or wheat seeds.

Treating seeds with the compositions of the disclosure or using the methods of the of the disclosure may lead to an improved yield by improving e.g., plant physiology, plant growth and development and/or plant architecture. In the context of the present disclosure “yield” includes, but is not limited to, (i) an increase in biomass production, grain yield, starch content, oil content and/or protein content, which may result from (a) an increase in the amount produced by the plant per se or (b) an improved ability to harvest plant matter, (ii) an improvement in the composition of the harvested material (e.g. improved sugar acid ratios, improved oil composition, increased nutritional value, reduction of anti-nutritional compounds, increased consumer health benefits) and/or (iii) an increased/facilitated ability to harvest the crop, improved processability of the crop and/or better storage stability/shelf life. Increased yield of an agricultural plant means that, where it is possible to take a quantitative measurement, the yield of a product of the respective plant is increased by a measurable amount over the yield of the same product of the plant produced under the same conditions, but without application of the present disclosure. According to the present disclosure, it is preferred that the yield be increased by at least 0.5%, more preferred at least 1%, even more preferred at least 2%, still more preferred at least 4%, preferably 5% or even more.

Certain embodiments of the disclosure are directed to processes for making the above-described compositions. Embodiments of methods of making include preparing or obtaining the agrochemical active ingredient, preparing or obtaining the other ingredients including the organic salt, and dissolving the agrochemical active ingredient in the organic salt.

Certain embodiments of the disclosure are as follows.

Embodiment 1. A composition, comprising:
an agrochemical active ingredient;
about 5-20% (w/w) of at least one organic salt; and
water.

Embodiment 2. The composition of Embodiment 1, wherein the agrochemical active ingredient is selected from at least one an insecticide, nematicide, and a fungicide.

Embodiment 3. The composition of Embodiment 1, further comprising 2 to 15% (w/w) a surfactant.

Embodiment 4. The composition of Embodiment 1, further comprising:
at least one of ethoxylated tridecyl- and/or isotridecyl alcohol; tristyrilphenol ethoxylate phospate ester; polyethylene glycol isodecyl ether; and complex organic phospate ester;
at least one of butyl EO/PO block copolymer, methyl methacrylate and metacrylic acid copolymer stabilized by hydrated PEG; sodium lignosulfonates, and naphthalenesulfonic acid sodium salt condensed with formaldehyde;
a vegetable oil or a silicone emulsion and a micronized wax;
a pigment dispersion; and
a thickener.

Embodiment 5. The composition of Embodiment 4, wherein each agrochemical active ingredient present in the composition is less than about 40% (w/w).

Embodiment 6. The composition of Embodiment 4, wherein each agrochemical active ingredient present in the composition is less than about 20% (w/w).

Embodiment 7. The composition of Embodiment 4, wherein each agrochemical active ingredient present in the composition is less than about 10% (w/w).

Embodiment 8. The composition of Embodiment 4, wherein the total agrochemical active ingredient present in the composition is about 1 to about 40% (w/w).

Embodiment 9. The composition of Embodiment 4, wherein the total agrochemical active ingredient present in the composition is about 2 to about 20% (w/w).

Embodiment 10. The composition of Embodiment 1, wherein the at least one organic salt is potassium formate.

Embodiment 11. The composition of Embodiment 1, wherein the at least one organic salt is potassium acetate.

Embodiment 12. The composition of Embodiment 1, wherein the at least one organic salt is about 7% w/w.

Embodiment 13. The composition of Embodiment 1, wherein the at least one organic salt is a combination of potassium formate and potassium acetate.

Embodiment 14. The composition of Embodiment 13, wherein the potassium formate is about 2.5% (w/w) and potassium acetate is about 2.5% (w/w).

Embodiment 15. The composition of Embodiment 1, wherein the composition remains a fluid at −5° C.

Embodiment 16. The composition of Embodiment 1, wherein the composition remains a fluid at −15° C.

Embodiment 17. The composition of Embodiment 1, wherein the composition has a viscosity between 200 and 600 cP at −5° C.

Embodiment 18. The composition of Embodiment 1, wherein the composition has a viscosity between 200 and 1100 cP at −15° C.

Embodiment 19. The composition of Embodiment 1, wherein the composition has a viscosity between 200 and 600 cP at −15° C.

Embodiment 20. The composition of Embodiment 1, further comprising a pigment dispersion and wherein the at least one organic salt is present in an amount that improves removing the pigment from application equipment relative to a composition without the organic salt.

Embodiment 21. The composition of Embodiment 1, wherein the composition provides germination of a seed substantially equivalent to an untreated seed.

Embodiment 22. The composition of Embodiment 1, wherein the composition provides vigor to a seed substantially equivalent to an untreated seed.

Embodiment 23. A combination package, comprising:
a first package comprising a seed treatment formulation; and
a second package comprising a solution comprising 15-90% (w/w) at least one organic salt, wherein the second package is about 5 to 100% v/v of the first package.

Embodiment 24. A method, for seed treatment comprising:
combining a seed treatment formulation with a solution comprising 15-90% (w/w) at least one organic salt, wherein the solution is about 5 to 100% v/v of the seed treatment formulation to form a slurry.

Embodiment 25. The method of Embodiment 24, further comprising applying the slurry to a seed.

Embodiment 26. The method of Embodiment 25, wherein the seed temperature during the applying is less than −5° C.

Embodiment 27. The method of Embodiment 25, wherein the seed temperature during the applying is less than −15° C.

Embodiment 28. The method of Embodiment 25, wherein the seed temperature during the applying is less than −25° C.

Embodiment 29. The method of Embodiment 25, wherein the germination of the seed is substantially equivalent to an untreated seed.

Embodiment 30. The method of Embodiment 25, wherein the vigor of the seed is substantially equivalent to an untreated seed.

Embodiment 31. A composition, comprising:
an agrochemical active ingredient;
about 1-7% (w/w) of at least one organic salt; and about 5-20% (w/w) an antifreeze agent which is not the at least one organic salt.

Embodiment 32. A method, comprising:
adding an organic salt to an agrochemical formulation until the organic salt is present in the seed treatment formulation at about 5-20% (w/w).

### EXAMPLES

The following examples are included to demonstrate embodiments of the disclosure. It should be appreciated by those of skill in the art that the techniques disclosed in the examples that follow represent techniques discovered by the inventors to function well in the practice of the disclosure, and thus can be considered to constitute preferred modes for its practice. However, those of skill in the art should, in light of the disclosure, appreciate that many changes can be made in the specific embodiments which are disclosed and still obtain a like or similar result without departing from the spirit and scope of the disclosure.

Where not otherwise specified throughout this specification and claims, percentages are w/w.

### Example 1: Preparation of Additives

### Additive 1

An aqueous solution of 65% w/w potassium formate was prepared by dissolving 65 g of potassium formate in 35 g of tap water. To accelerate dissolution, the temperature was increased to 50° C. No crystallization was observed in the obtained solution after two months storage at −20° C.

### Additive 2

A solution was prepared by mixing 25 g of tap water (T=50° C.) with 50 g of potassium acetate. Once a homogeneous mixture was present, 25 g of trehalose was added to the solution. No crystallization was observed in the obtained solution after two months storage at −15° C.

### Additive 3

A solution was prepared by mixing 30 g of tap water with 20 g of ethanol. 50 g of potassium acetate was added to the obtained solution. The salt was fully dissolved after vigorous mixing for 60 min at room temperature. No crystallization was observed in the obtained solution after two months storage at −20° C.

### Additive 4

30 g of tap water was placed in a beaker and heated to 50° C. 35 g of potassium formate was added to the aqueous solution and stirred until the salt was fully dissolved. Then, 35 g of potassium acetate was added, and the solution was mixed until complete dissolution of all salt crystals. No crystallization was observed in the obtained solution after two months storage at −20° C.

### Additive 5

50 g of tap water was mixed with 50 g of potassium acetate. The temperature of the solution was raised to 50° C. and maintained until complete dissolution of the salt. No crystallization was observed in the obtained solution after two months storage at −20° C.

### Example 2: Evaluation of Seed Treatment Slurries with Additives

### Additive 1+Vibrance® Quattro

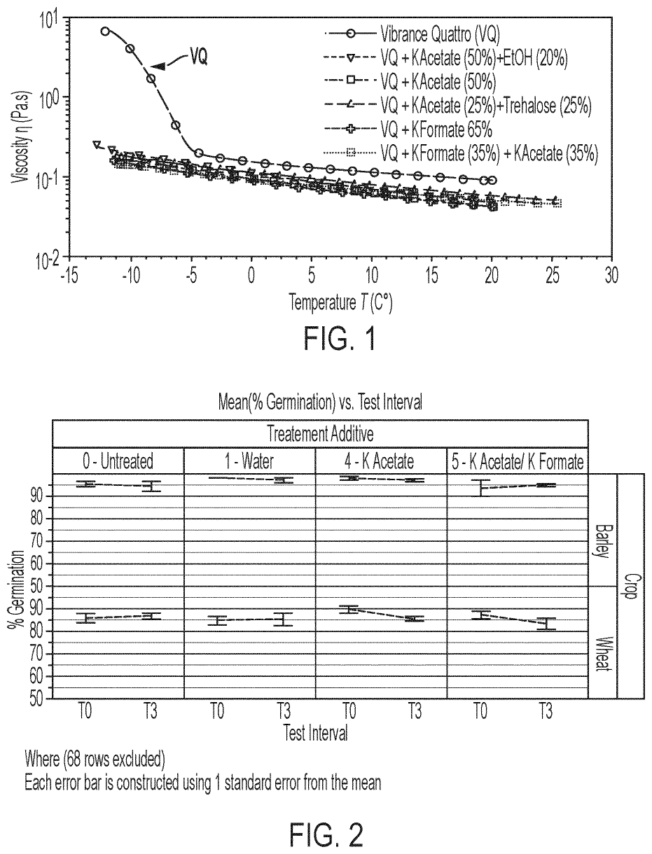

90 ml of Vibrance® Quattro and 10 ml of additive 1 were placed into a beaker. The mixture was vigorously stirred. The viscosity of the neat Vibrance® Quattro formulation was 435 cP. After adding 10 v/v % of additive 1, the viscosity of the mixture was reduced to 146 cP. Particle size distribution, pH, and viscosity was monitored for three days. No additional changes were observed over this time frame. The mixture remained a liquid after three days storage at T=−15° C., with a viscosity of 700 cP at this temperature. A rheology profile (viscosity vs temperature) is shown in FIG. 1.

### Additive 2+Vibrance® Quattro

90 ml of Vibrance® Quattro and 10 ml of additive 2 were placed in a beaker. The mixture was vigorously stirred. After adding 10 v/v % of additive 2, the viscosity of the mixture was reduced to 157 cP. Particle size distribution, pH, and viscosity was monitored for three days. No additional changes were observed over this time frame. The mixture remained liquid after three days storage at T=−15° C. A rheology profile (viscosity vs temperature) is shown in FIG. 1.

### Additive 3+Vibrance® Quattro

90 ml of Vibrance Quattro and 10 ml of additive 3 were placed into a beaker. The mixture was vigorously stirred. After adding 10 v/v % of additive 3, the viscosity of the mixture was reduced to 228 cP. Particle size distribution, pH, and viscosity was monitored for three days. No additional changes were observed over this time frame. The mixture remained liquid after three days storage at T=−15° C. A rheology profile (viscosity vs temperature) is shown in FIG. 1.

### Additive 4+Vibrance® Quattro

90 ml of Vibrance Quattro and 10 ml of additive 4 were placed into a beaker. The mixture was vigorously stirred. After adding 10 v/v % of additive 4, the viscosity of the mixture was reduced to 186 cP. Particle size distribution, pH, and viscosity was monitored for three days. No additional changes were observed over this time frame. The mixture remained liquid after three days storage at T=−15° C. A rheology profile (viscosity vs temperature) is shown in FIG. 1.

### Additive 5+Vibrance® Quattro

90 ml of Vibrance Quattro and 10 ml of additive 5 were placed into a beaker. The mixture was vigorously stirred. After adding 10 v/v % of additive 5, the viscosity of the mixture was reduced to 182 cP. Particle size distribution, pH, and viscosity was monitored for three days. No additional changes were observed over this time frame. The mixture remained liquid after three days storage at T=−15° C. A rheology profile (viscosity vs temperature) is shown in FIG. 1.

The transition observed for the neat Vibrance Quattro formulation is indicative of the freezing process in the slurry. Additives 1-5 dosed at 10% v/v of a Vibrance Quattro product do not exhibit any freezing transitions and, typically, extend the useful application range down to −15° C. compared to a maximum built-in freeze protection for Vibrance® Quattro of −5° C. The mixture allows for maintaining the liquid state of the slurry which extends the application window by about 10° C. (down to −15° C.).

### Example 3: Evaluation of Seed Safety

Seed safety was tested in wheat and barley using standard (warm germination) and vigor (cold conditioning) methods. For the standard method, seeds were coated with slurries containing Vibrance® Quattro and one of the additives 1-5 dosed at 10% v/v. Seeds were planted between two wet towels and held at 5° C. for 5 days to overcome dormancy. The seeds were then incubated at 20° C. and evaluated on day 7 (TO) and after 3 months (T3).

The vigor test was used to determine germination potential under stressful conditions. The cold test, a type of vigor test, was used to create a period of imbibitional chilling in a soil environment with natural fungal and microbial activity that can present some challenges to seeds in the field. In the cold test, seeds are planted on towels wetted with water. Samples are then chilled to 5° C. and evaluated on day 12.

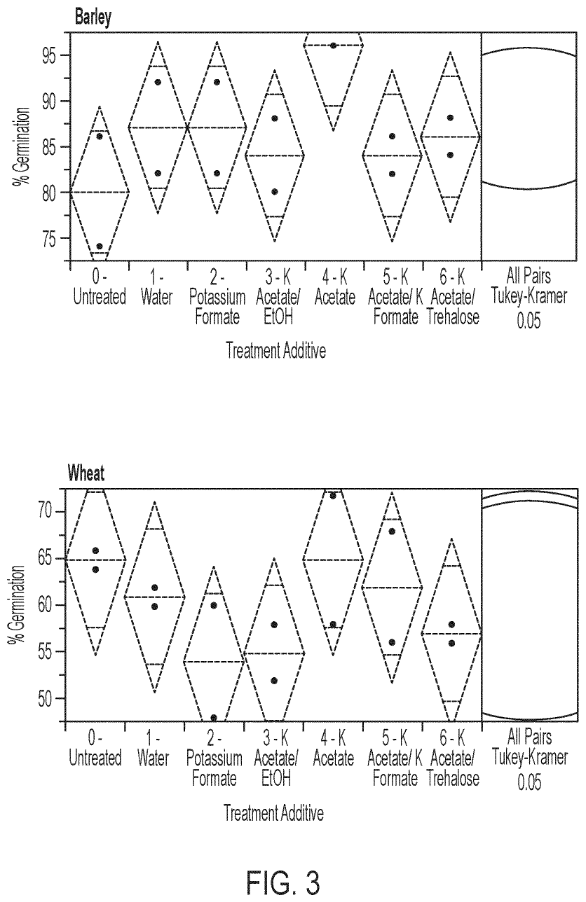

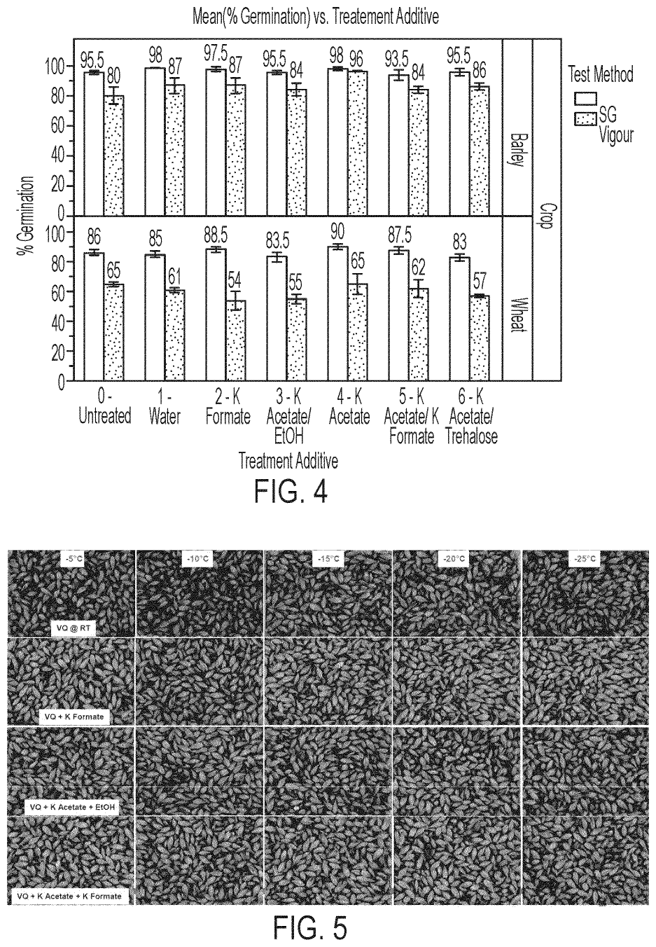

No negative seed safety impacts were observed on wheat and barley at the initial time point (TO) or at three months storage (T3) for standard and vigor test methods (FIGS. 2-4). FIG. 2 shows standard germination at TO and T3 time points; FIG. 3 shows standard germination-TO results; and FIG. 4 shows seed safety assessment for wheat and barley at TO.

### Example 4: Cold Temperature Application

The assessment of seed coverage was performed for with Vibrance® Quattro and Vibrance® Quattro with one of the additives 1, 3, and 4 dosed at 10% v/v of a Syngenta product. The seed coating slurry was kept at −15° C. and the seeds were stored at various temperatures (FIG. 5). Additive 2 was too thick with ice crystals and removed from further screening. The seed coverage was good, and the seeds were fairly dry for all treatment conditions. The equipment shows that build up is light and not tacky for all treatments and treatment conditions. Additionally, the equipment was easily cleaned.

### Example 5: Storage Stability

To test storage stability of compositions containing organic salts as an antifreeze agent, Vibrance Quattro with 10% w/w additive 1 or 4 or water was prepared. The mixtures were stored at −10° C. and the particle size within the mixtures was monitored over time using a Malvern 2000. The results are provided in Table 2, below:

TABLE 2

| | D50, | D50, | D50, | D90, | D90, | D90, |
|---|---|---|---|---|---|---|
| Additive | t0 | 4 days | 13 days | t0 | 4 days | 13 days |
| Water | 1.18 | 1.069 | 1.24 | 15.03 | 15.08 | 15.13 |
| Additive 1 | 1.24 | 1.48 | 1.24 | 16.01 | 15.45 | 15.62 |
| Additive 4 | 1.28 | 1.53 | 1.25 | 15.01 | 15.15 | 15.81 |

As illustrated by the data in Table 2, the particle size for D50 and D90 did not increase to unacceptable levels after 13 days.

Although the particular embodiments have been described in some detail by way of illustration and example for purposes of clarity of understanding, it is readily apparent in light of the teachings of this disclosure that certain changes and modifications may be made thereto without departing from the spirit or scope of the appended claims.

Accordingly, the preceding merely illustrates the principles of the disclosure. Various arrangements may be devised which, although not explicitly described or shown herein, embody the principles of the disclosure and are included within its spirit and scope. Furthermore, all examples and conditional language recited herein are principally intended to aid the reader in understanding the principles of the disclosure and the concepts contributed by the inventors to furthering the art, and are to be construed as being without limitation to such specifically recited examples and conditions. In addition, all statements herein reciting principles, aspects, and embodiments of the disclosure as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary embodiments shown and described herein. Rather, the scope and spirit of present disclosure is embodied by the appended claims.

1. A composition, comprising:
an agrochemical active ingredient;
about 5-20% (w/w) of at least one organic salt; and
water.

2. The composition of claim 1, wherein the agrochemical active ingredient is selected from at least one an insecticide, nematicide, and a fungicide.

3. The composition of claim 1, further comprising 2 to 15% (w/w) a surfactant.

4. The composition according to claim 1, further comprising:
at least one of ethoxylated tridecyl- and/or isotridecyl alcohol; tristyrilphenol ethoxylate phosphate ester; polyethylene glycol isodecyl ether; and complex organic phosphate ester;
at least one of butyl EO/PO block copolymer, methyl methacrylate and methacrylic acid copolymer stabilized by hydrated PEG; sodium lignosulfonates, and naphthalenesulfonic acid sodium salt condensed with formaldehyde;
a vegetable oil or a silicone emulsion and a micronized wax;
a pigment dispersion; and
a thickener.

5. The composition according to claim 1, wherein each agrochemical active ingredient present in the composition is less than about 40% (w/w), preferably less than about 20% (w/w), and more preferably less than about 10% (w/w).

6. The composition according to claim 1, wherein the total agrochemical active ingredient present in the composition is about 1 to about 40% (w/w), and preferably about 2 to about 20% (w/w).

7. The composition according to claim 1, wherein the at least one organic salt is selected among potassium formate, potassium acetate, and a combination of potassium formate and potassium acetate.

8. The composition according to claim 1, wherein the at least one organic salt is about 7% w/w.

9. The composition according to claim 1, wherein the potassium formate is about 2.5% (w/w) and potassium acetate is about 2.5% (w/w), when the at least one organic salt is a combination of potassium formate and potassium acetate.

10. The composition according to claim 1, wherein the composition remains a fluid at −5° C., and preferably at −15° C.

11. The composition according to claim 1, wherein the composition has a viscosity between 200 and 600 cP at −5° C.

12. The composition according to claim 1, wherein the composition has a viscosity between 200 and 1100 cP at −15° C., and preferably between 200 and 600 cP at −15° C.

13. The composition according to claim 1, further comprising a pigment dispersion and wherein the at least one organic salt is present in an amount that improves removing the pigment from application equipment relative to a composition without the organic salt.

14. The composition according to claim 1, wherein the composition provides germination of a seed substantially equivalent to an untreated seed and/or vigor to a seed substantially equivalent to an untreated seed.

15. A combination package, comprising:
a first package comprising a seed treatment formulation; and
a second package comprising a solution comprising 15-90% (w/w) at least one organic salt, wherein the second package is about 5 to 100% v/v of the first package.

16. A method, for seed treatment comprising:
combining a seed treatment formulation with a solution comprising 15-90% (w/w) at least one organic salt, wherein the solution is about 5 to 100% v/v of the seed treatment formulation to form a slurry.

17. The method of claim 16, further comprising applying the slurry to a seed.

18. The method of claim 16, wherein the seed temperature during the applying is less than −5° C., preferably less than −15° C., and more preferably less than −25° C.

19. The method of according to claim 16, wherein the germination of the seed is substantially equivalent to an untreated seed and/or substantially equivalent to an untreated seed.

20. A composition, comprising:
an agrochemical active ingredient;
about 1-7% (w/w) of at least one organic salt; and
about 5-20% (w/w) an antifreeze agent which is not the at least one organic salt.

21. A method, comprising:
adding an organic salt to an agrochemical formulation until the organic salt is present in the seed treatment formulation at about 5-20% (w/w).
